(19) United States
(12) Patent Application Publication
(10) Pub. No.: US 2026/0208278 A1
(43) Pub. Date: Jul. 23, 2026

(54) BANDSAW BRAKING DEVICE

(71) Applicant: William Brook, Pleasant Hill, CA (US)

(72) Inventor: William Brook, Pleasant Hill, CA (US)

(21) Appl. No.: 19/034,230

(22) Filed: Jan. 22, 2025

(51) Int. Cl. B23D 55/06; B23D 55/00

(52) U.S. Cl. CPC B23D 55/065; B23D 55/005

(57) ABSTRACT

A bandsaw braking device includes a bandsaw that has a drive wheel located in a drive wheel housing and a door in the drive wheel housing. A sleeve is extendable through a sleeve hole in the door of the wheel housing and a bushing is extendable through the sleeve. A plunger is slidably positioned in the bushing and the plunger can be pushed upon by a user. A brake pad is removably attachable to the plunger and the brake pad presses against the drive wheel when the plunger is pushed upon to stop rotation of the bandsaw when the user depresses the plunger. Conversely, the plunger is biased to travel away from the drive wheel having the brake pad being spaced from the drive wheel such that the drive wheel can rotate freely.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to braking devices and more particularly pertains to a new braking device for bringing a moving bandsaw to a stop. The device includes a sleeve that is extendable through a door of a drive wheel housing of a band saw and a plunger that is slidably positioned in the sleeve. The device includes a brake pad attached to one end of the plunger and a knob attached to an opposite end of the plunger from the brake pad. The brake pad presses against a drive wheel in the drive wheel housing when a user presses upon the knob to bring the drive wheel to a stop when the bandsaw is turned off.

### (2) Description of Related Art Including Information Disclosed Under 37 CFR 1.97 and 1.98

The prior art relates to braking devices including: a safety brake device for a band saw which includes a pivot arm that is pivotally coupled to a drive wheel housing of a bandsaw and which presses against a blade of the bandsaw to bring the blade to a stop when the bandsaw is turned off; a spring brake device that includes an electric saw motor and a brake pad positioned around an output shaft of the electric saw motor and a T-bar handle which presses the brake pad against the output shaft when the T-bar handle is depressed; an emergency stop device that includes a brake member which is pivotally disposed in a drive wheel housing of a bandsaw and a biasing member which biases the brake member to press against an outer surface of a drive wheel to bring the drive wheel to a stop and a solenoid to pivot the brake member away from the outer surface of the drive wheel; a band saw brake device that includes a foot pedal pivotally mounted to a bandsaw and a brake positioned against an outer surface of a drive wheel which is in mechanical communication with the foot pedal such that the brake stops the drive wheel when the foot pedal is depressed. In no instance does the prior art disclose a bandsaw braking device that includes a plunger that is extendable through a door of a drive wheel housing of a bandsaw and a knob coupled to the plunger that can be pushed upon by a user and a brake pad coupled to the plunger that presses against a lateral surface of a drive wheel when the knob is pushed upon by the user to stop the drive wheel.

### (h) BRIEF SUMMARY OF THE INVENTION

An embodiment of the disclosure meets the needs presented above by generally comprising a bandsaw that has a drive wheel located in a drive wheel housing and a door in the drive wheel housing. A sleeve is extendable through a sleeve hole in the door of the wheel housing and a bushing is extendable through the sleeve. A plunger is slidably positioned in the bushing and the plunger can be pushed upon by a user. A brake pad is removably attachable to the plunger and the brake pad presses against the drive wheel when the plunger is pushed upon to stop rotation of the bandsaw when the user depresses the plunger. Conversely, the plunger is biased to travel away from the drive wheel having the brake pad being spaced from the drive wheel such that the drive wheel can rotate freely.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom perspective view of a bandsaw braking device according to an embodiment of the disclosure.

FIG. 2 is a right side view of an embodiment of the disclosure.

FIG. 3 is a front in-use view of an embodiment of the disclosure.

FIG. 4 is a front perspective view of an embodiment of the disclosure.

FIG. 5 is a front in-use view of an embodiment of the disclosure showing a user pressing on a knob.

FIG. 6 is a phantom in-use view of an embodiment of the disclosure showing a brake pad being pressed against a lateral surface of a drive wheel.

FIG. 7 is an exploded front perspective view of an embodiment of the disclosure.

FIG. 8 is an exploded back perspective view of an embodiment of the disclosure.

FIG. 9 is a perspective view of an alternative embodiment of the disclosure.

FIG. 10 is a right side phantom view of an alternative embodiment of the disclosure.

FIG. 11 is a perspective in-use view of an alternative embodiment of the disclosure.

FIG. 12 is a cross sectional view taken along line 12-12 of FIG. 2 of an embodiment of the disclosure.

FIG. 13 is a magnified detail view taken from circle 13 of FIG. 8 of an embodiment of the disclosure.

### (j) DETAILED DESCRIPTION OF THE INVENTION

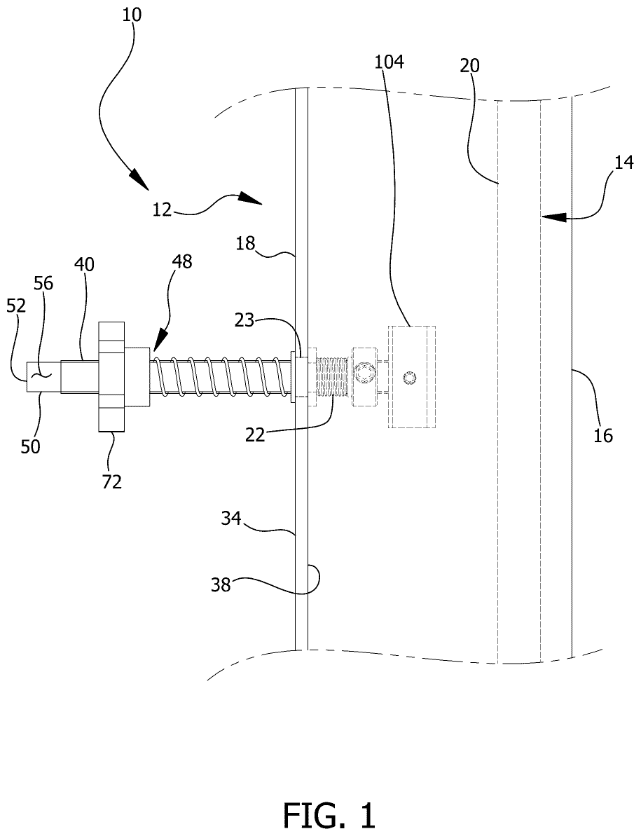

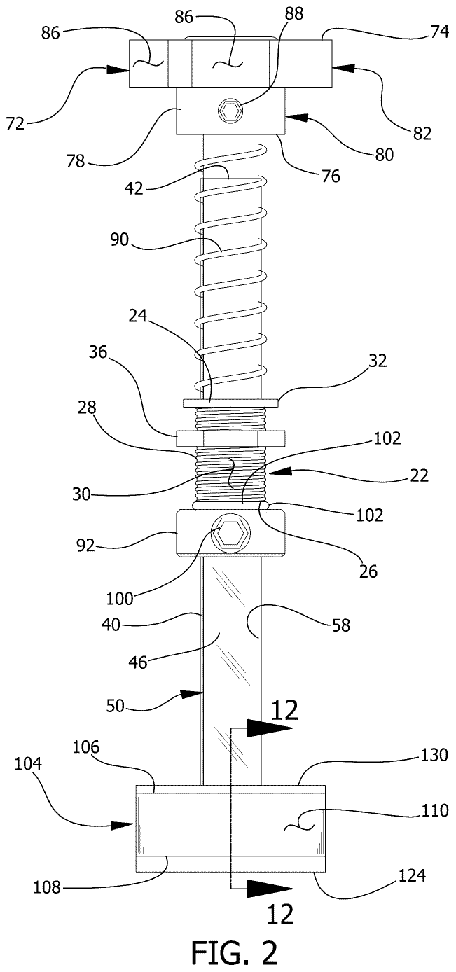

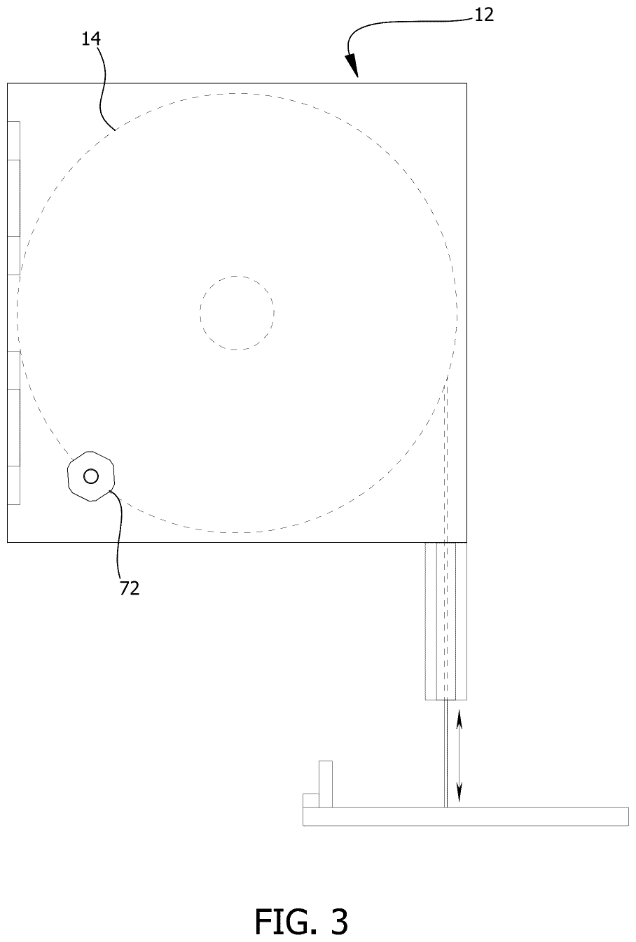

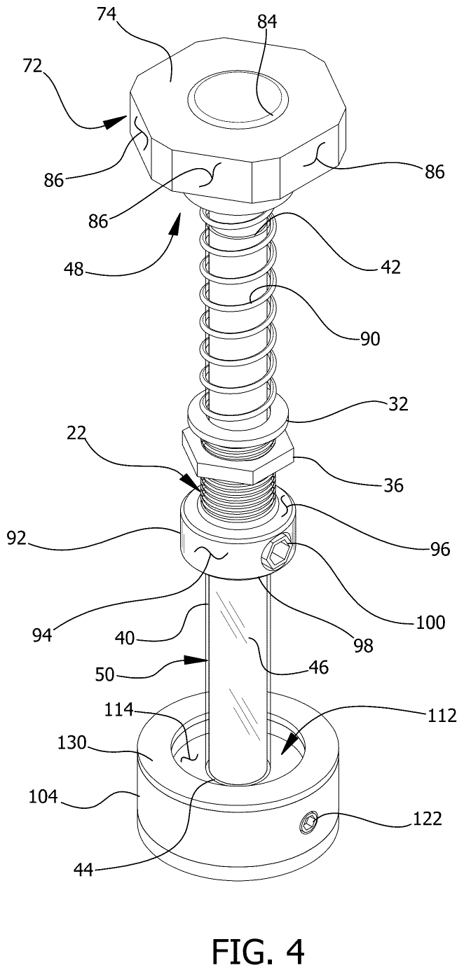

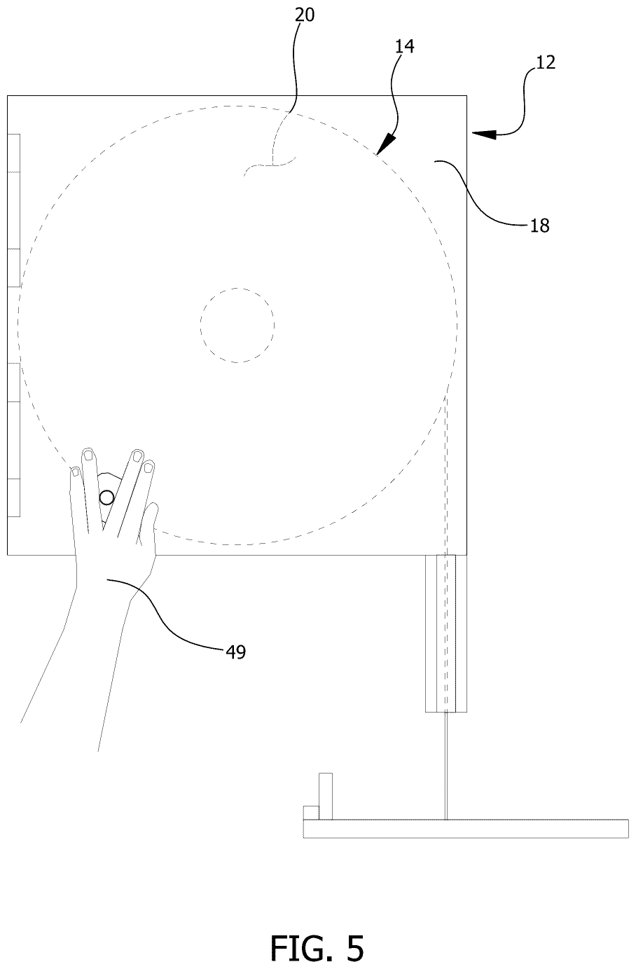

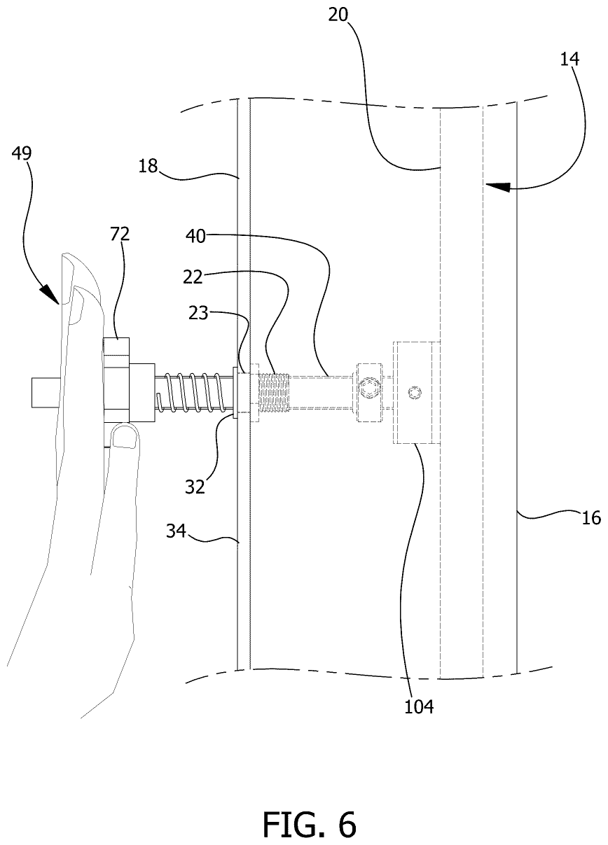

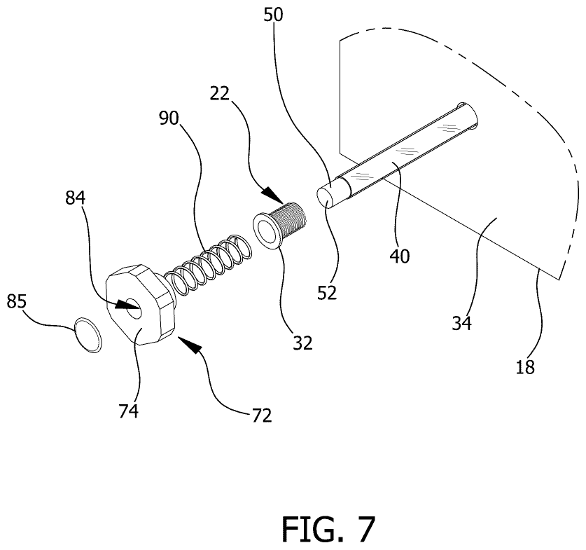

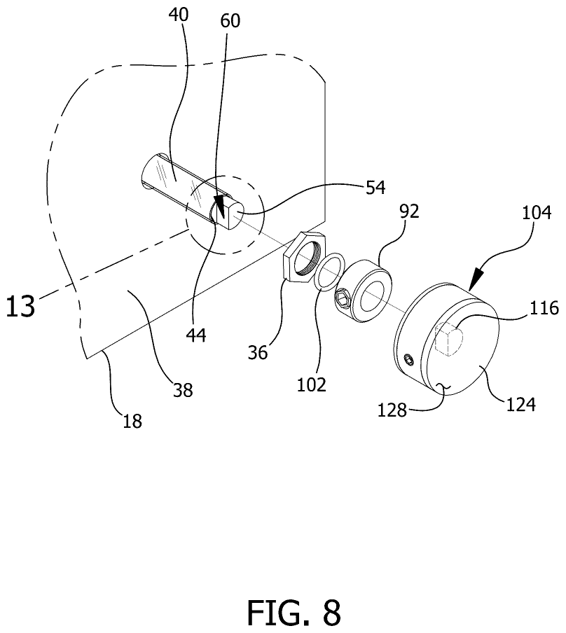

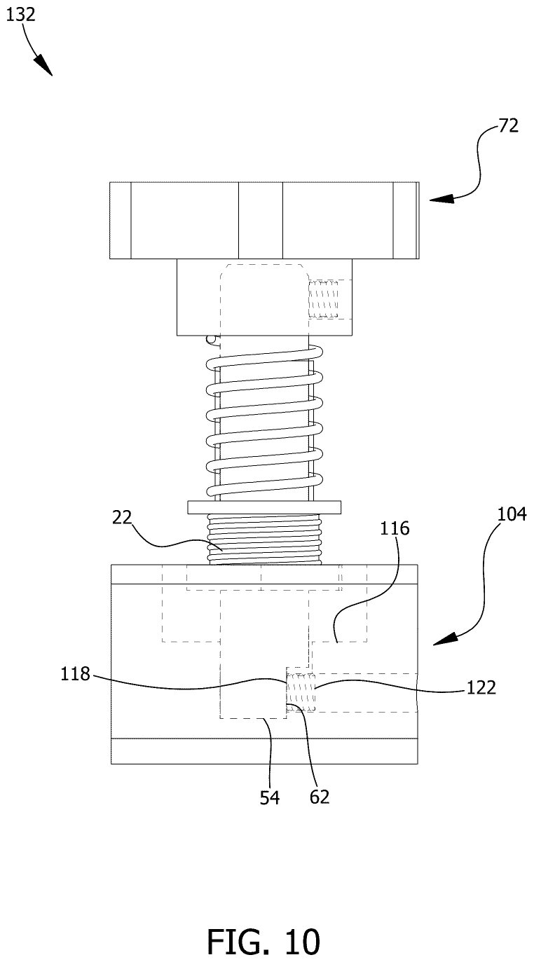

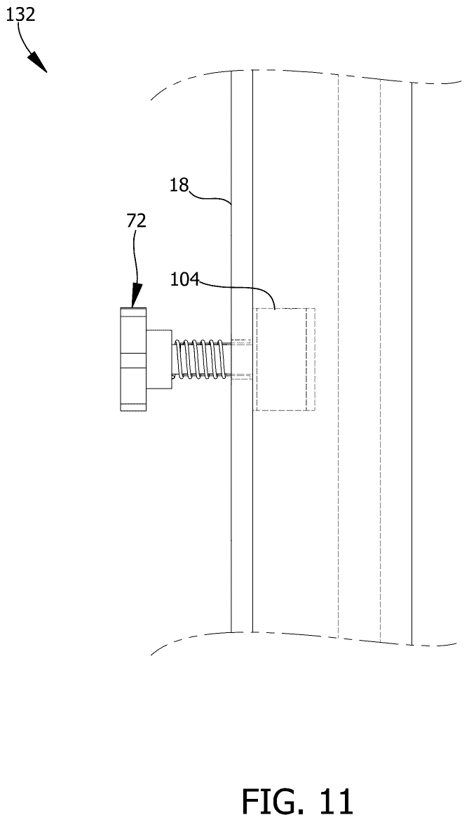

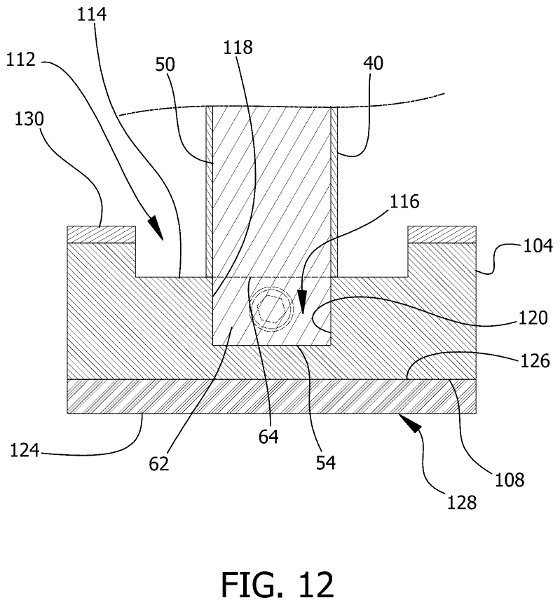

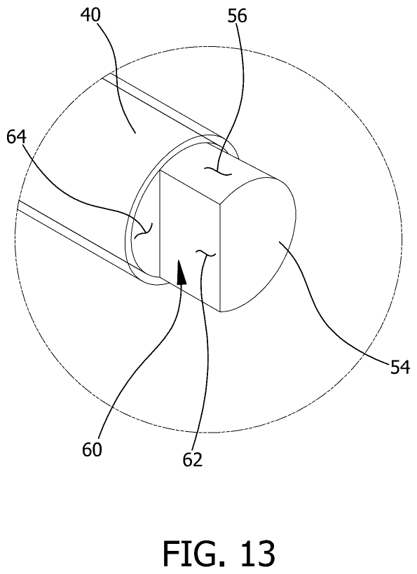

With reference now to the drawings, and in particular to FIGS. 1 through 13 thereof, a new braking device embodying the principles and concepts of an embodiment of the disclosure and generally designated by the reference numeral 10 will be described.

As best illustrated in FIGS. 1 through 13, the bandsaw braking device 10 generally comprises a bandsaw 12 that has a drive wheel 14 which is located in a drive wheel housing 16. The drive wheel housing 16 has a door 18 which lies on a plane that is oriented parallel to a lateral surface 20 of the drive wheel 14. The bandsaw 12 may be an electric band saw of any conventional design that might be found in a manufacturing setting or an industrial setting, for example.

A sleeve 22 is extendable through a sleeve hole 23 in the door 18 of the wheel housing. The sleeve 22 has a first end 24 and a second end 26 and an outer wall 28 extending between the first end 24 and the second end 26, and the outer wall 28 has an outer surface 30 which is threaded between the first end 24 and the second end 26. Additionally, the sleeve 22 has a lip 32 extending away from the outer wall 28 having the lip 32 extending around a full circumference of the outer wall 28. The lip 32 is aligned with the first end 24 such that the lip 32 rests against an outer face 34 of the door 18 when the sleeve 22 is extended through the sleeve hole 23. A nut 36 is threadable onto the outer surface 30 of the sleeve 22 and the nut 36 compresses against an inner face 38 of the door 18 when the nut 36 is tightened on the sleeve 22 for securing the sleeve 22 in the sleeve hole 23.

A bushing 40 is extendable through the sleeve 22 such that the bushing 40 extends through the door 18. The bushing 40 has a primary end 42 and a secondary end 44 and an exterior wall 46 extending between the primary end 42 and the secondary end 44; the bushing 40 has a length between the primary end 42 and the secondary end 44 which is greater than a length of the sleeve 22 between the first end 24 and the second end 26. Furthermore, the bushing 40 is comprised of a friction reducing material, including but not being limited to nylon or plastic, such that the bushing 40 slides freely in the sleeve 22. The sleeve 22 may be comprised of a rigid material, including but not being limited to steel or aluminum, such that the sleeve 22 can resist being deformed.

A plunger 48 is slidably positioned in the bushing 40 such that the plunger 48 can be pushed upon by a user 49. The plunger 48 extends toward the drive wheel 14 when the plunger 48 is urged to travel in a primary direction. Conversely, the plunger 48 is biased to travel in a secondary direction. The plunger 48 includes a shaft 50 which has first end 52 and a second end 54 and an outside surface 56 extending between the first end 52 of the shaft 50 and the second end 54 of the shaft 50. The shaft 50 extends through the bushing 40 having the outside surface 56 slidably engaging an interior surface 58 of the exterior wall 46 of the bushing 40. The shaft 50 is comprised of a rigid material, including but not being limited to steel or aluminum, such that the shaft 50 can resist being deformed by the force that can be generated by the user 49.

The outside surface 56 of the shaft 50 has a cut out portion 60 extending from the second end 54 of the shaft 50 toward the first end 52 of the shaft 50. The cut out portion 60 has a first bounding surface 62 lying on a plane which is oriented perpendicular to the second end 54. Additionally, the cut out portion 60 has a second bounding surface 64 that is oriented perpendicular to the first bounding surface 62 and the second bounding surface 64 lies on a plane which is oriented parallel to the second end 54.

The plunger 48 includes a knob 72 which has a front end 74 and a back end 76 and an exterior wall 78 extending between the front end 74 and the back end 76. The exterior wall 78 of the knob 72 has a receiver section 80 and a gripping section 82; the receiver section 80 has a diameter which is less than a diameter of the gripping section 82. The knob 72 has a shaft hole 84 extending through the front end 74 and the back end 76 and the shaft 50 extends through the shaft hole 84; the knob 72 is slidably positioned on the shaft 50 having the back end 76 being spaced from the primary end 42 of the bushing 40. A cap 85 is removably attachable to the front end 74 of the knob 72 to cover the shaft hole 84.

The exterior wall 78 of the knob 72 associated with the gripping section 82 has a plurality of intersecting surfaces 86 oriented at an angle with each other such that the gripping section 82 has a polygonal shape to enhance a grip of the user 49 when the user 49 grips the gripping section 82. The plunger 48 includes a knob set screw 88 which extends through the receiver section 80 of the exterior wall 46 and into the shaft hole 84. The knob set screw 88 compresses against the outside surface 56 of the shaft 50 when the knob set screw 88 is tightened for retaining the knob 72 at a selected point along the shaft 50. The plunger 48 includes a biasing member 90 which extends around the bushing 40 and the biasing member 90 extends between the lip 32 on the sleeve 22 and the back end 76 of the knob 72. The biasing member 90 biases the knob 72 to travel away from the sleeve 22 and the biasing member 90 is compressed when the knob 72 is urged to travel toward the sleeve 22. The shaft 50 travels in a primary direction when the knob 72 is urged to travel toward the sleeve 22 and the shaft 50 travels in secondary direction when the knob 72 is biased to travel away from the sleeve 22.

The plunger 48 includes a locking collar 92 which has an outwardly facing surface 94 extending between a forward surface 96 and a rearward surface 98. The bushing 40 extends through the locking collar 92 having the forward surface 96 resting against the second end 26 of the sleeve 22. Furthermore, the forward surface 96 of the locking collar 92 abuts the second end 26 of the sleeve 22 when the biasing member 90 biases the knob 72 to travel away from the sleeve 22; the locking collar 92 limits the distance the shaft 50 can travel in the secondary direction. The locking collar 92 is positionable on the bushing 40 such that the back surface 68 of the head 62 is spaced a selected distance from the drive wheel 14 of the bandsaw 12 when the biasing member 90 biases the knob 72 to travel away from the sleeve 22. Additionally, the locking collar 92 enables the distance between the lateral surface 20 of the drive wheel 14 and the back surface 68 of the head 62 to be adjusted.

The plunger 48 includes a collar set screw 100 which extends through the outwardly facing surface 94 of the locking collar 92. The collar set screw 100 compresses against the exterior wall 46 of the bushing 40 when the collar set screw 100 is tightened to inhibit the locking collar 92 from sliding along the exterior wall 46 of the bushing 40. Additionally, the collar set screw 100 enables the locking collar 92 to adjust the distance between the head 62 and the sleeve 22 when the knob 72 is fully biased away from the sleeve 22. The plunger 48 includes an annular gasket 102 which is positioned around the bushing 40 and the annular gasket 102 is positioned between the forward surface 96 of the locking collar 92 and the second end of the sleeve 22. The annular gasket 102 is comprised of resiliently compressible material, including but not being limited to rubber or silicone, such that the annular gasket 102 is compressed between the forward surface 96 of the locking collar 92 and the second end 26 of the sleeve 22 when the biasing member 90 biases the knob 72 to travel away from the sleeve 22 to reduce noise produced by vibration of the bandsaw 12.

A brake pad 104 is provided and the brake pad 104 is removably attachable to the plunger 48. The brake pad 104 frictionally engages against the drive wheel 14 when the plunger 48 is urged to travel in the primary direction such that the brake pad 104 stops a rotational speed of the drive wheel 14. The brake pad 104 is thusly equipped to stop rotation of the bandsaw 12 when the user 49 presses the plunger 48. Conversely, the brake pad 104 is spaced from the drive wheel 14 when the plunger 48 is biased to travel in the secondary direction such that the drive wheel 14 can rotate freely.

The brake pad 104 has a forward end 106 and a rear end 108 and an outermost surface 110 extending between the forward end 106 and the rear end 108. The forward end 106 has a first well 112 extending toward the rear end 108 and the first well 112 has a rear bounding surface 114. The rear bounding surface 114 has a second well 116 extending toward the rear end 108 and the second well 116 has a first lateral bounding surface 118 and a second lateral bounding surface 120. The first lateral bounding surface 118 is oriented perpendicular to the rear bounding surface 116 and the second lateral bounding surface 120 is concavely arcuate with respect to the first lateral bounding surface 118 such that the second well 116 has a semicircular shape. The second well 116 insertably receives the second end 54 of the shaft 50 having the first bounding surface 62 of the cut out portion 60 of the outside surface 56 of the shaft 50 conforming to the first lateral bounding surface 118 of the second well 116 such that the shaft 50 is inhibited from rotating in the second well 116.

A brake set screw 122 is provided and the brake set screw 122 extends through the outermost surface 110 of the brake pad 104. The brake set screw 122 compresses against the first bounding surface 62 of the cut out portion 60 of the outside surface 56 of the shaft 50 when the brake set screw 122 is tightened for retaining the brake pad 104 on the head 62. A friction pad 124 is provided which has a coupled surface 126 that is coupled to the rear end 108 of the brake pad 104 having the coupled surface 126 completely covering the rear end 108. An exposed surface 128 of the friction pad 124 presses against the lateral surface 20 of the drive wheel 14 when the knob 72 is urged toward the sleeve 22 to produce friction between the lateral surface 20 of the drive wheel 14 and the exposed surface of the friction pad 124. The friction pad 124 may be comprised of a wear resistant material, including but not being limited to ceramic or asbestos, to enhance the service life of the friction pad 124.

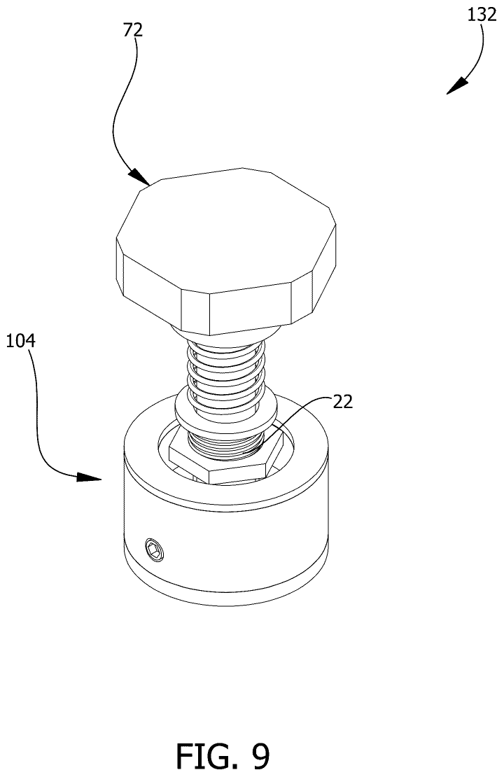

A cushion 130 is applied to the front end 74 of the brake pad 104 having the cushion 130 extending around the first well 112. The cushion 130 is comprised of a resiliently compressible material, including but not being limited to rubber or silicone, such that the cushion 130 is compressed between the front end 74 of the brake pad 104 and the inner face 38 of the door 18 when the biasing member 90 biases the knob 72 to travel away from the sleeve 22. Furthermore, the cushion 130 reduces noise produced by vibration of the bandsaw 12. The locking collar 92 and the shaft hole 84 in the knob 72 enable the plunger 48 and the brake pad 104 to be retrofitted onto various makes and models of bandsaws that each have unique spacing between the drive wheel 14 and the door 18 of the drive wheel housing 16. The shaft 50 can be cut to length, if needed or if preferred by the user 49, to adapt the shaft 50 to the spacing between the drive wheel 14 and the door 18 of the drive wheel housing 16. In an alternative embodiment 132 as is shown in FIGS. 9 through 11, the shaft 50 is manufactured to a length of a specific make and model of bandsaw such that the locking collar 92 is not required to adjust the length between the brake pad 104 and the sleeve 22. Additionally, the height of the brake pad 104 between the forward end 106 of the brake pad 104 and the rear end 108 of the brake pad 104 may be specific to the spacing between the lateral surface 20 of the drive wheel 14 and the door 18 of the drive wheel housing 16.

In use, a sleeve hole 23 is drilled into the door 18 of the drive wheel housing 16 at location chosen by the user 49 and the sleeve 22 is inserted through the sleeve hole 23 and the nut 36 is threaded on the sleeve 22 to secure the sleeve 22 in the sleeve hole 23. The bushing 40 is inserted through the sleeve 22 and the shaft 50 is inserted through the bushing 40 such that the brake pad 104 is positioned between the door 18 and the lateral surface 20 of the drive wheel 14. The locking collar 92 is secured with the collar set screw 100 at desired point along the bushing 40 to space the brake pad 104 a desired distance from the lateral surface 20 of the drive wheel 14 when the door 18 is closed. The biasing member 90 is slid onto the first end of the shaft 50 and the knob 72 is slid onto the first end of the shaft 50 such that the biasing member 90 is positioned between the knob 72 and the door 18. The knob set screw 88 is tightened to retain the knob 72 at a desired point on the shaft 50. The user 49 depresses the knob 72 to compress the brake pad 104 against the lateral surface 20 of the drive wheel 14 then the bandsaw 12 has been turned off to quickly bring the rotation of the drive wheel 14 to a stop. Furthermore, the bandsaw 12 is safely brought to a stop in a safe and timely manner when the bandsaw 12 is turned off such that the user 49 can maintain or service the bandsaw 12 without having to wait for the bandsaw 12 to come to a stop on its own when the bandsaw 12 is turned off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bandsaw braking device comprising, said device comprising:
a bandsaw having a drive wheel being located in a drive wheel housing, said drive wheel housing having a door lying on a plane being oriented parallel to said drive wheel, said door having a sleeve hole extending through said door;
a sleeve being extendable through said sleeve hole in said door of said wheel housing;
a bushing being extendable through said sleeve such that said bushing extends through said door;
a plunger being slidably positioned in said bushing wherein said plunger is configured to be pushed upon by a user, said plunger extending toward said drive wheel when said plunger is urged to travel in a first direction, said plunger being biased to travel in a second direction; and
a brake pad being removably attachable to said plunger, said brake pad pressing against said drive wheel when said plunger is urged to travel in said first direction having said brake pad frictionally engaging said drive wheel such that said brake pad stops rotation of said drive wheel wherein said brake pad is configured to stop rotation of said bandsaw when the user presses upon said plunger, said brake pad being spaced from said drive wheel when said plunger is biased to travel in said second direction such that said drive wheel can rotate freely.

2. The device according to claim 1, wherein:
said sleeve has a first end and a second end and an outer wall extending between said first end and said second end;
said outer wall has an outer surface being threaded between said first end and said second end;
said sleeve has a lip extending away from said outer wall having said lip extending around a full circumference of said outer wall;
said lip is aligned with said first end such that said lip rests against an outer face of said door when said sleeve is extended through said sleeve hole;
said device includes a nut being threadable onto said outer surface of said sleeve; and
said nut compresses against an inner face of said door when said nut is tightened on said sleeve for securing said sleeve in said sleeve hole.

3. The device according to claim 1, wherein:
said sleeve has a first end and a second end;
said bushing has a primary end and a secondary end and an exterior wall extending between said primary end and said secondary end;
said bushing has a length between said primary end and said secondary end which is greater than a length of said sleeve between said first end and said second end; and
said bushing is comprised of a friction reducing material such that said bushing slides freely in said sleeve.

4. The device according to claim 3, wherein:
said plunger includes a shaft having first end and a second end and an outside surface extending between said first end of said shaft and said second end of said shaft; and
said shaft extends through said bushing having said outside surface slidably engaging an interior surface of said exterior wall of said bushing.

5. The device according to claim 4, wherein
said outside surface having a cut out portion extending from said second end of said shaft toward said first end of said shaft;
said cut out portion having a first bounding surface lying on a plane being oriented perpendicular to said second end;
said cut out portion having a second bounding surface being oriented perpendicular to said first bounding surface; and
said second bounding surface lying on a plane being oriented parallel to said second end.

6. The device according to claim 4, wherein:
said plunger includes a knob having a front end and a back end and an exterior wall extending between said front end and said back end;
said exterior wall of said knob has a receiver section and a gripping section;
said receiver section has a diameter being less than a diameter of said gripping section;
said knob has a shaft hole extending through said front end and said back end; and
said shaft extends through said shaft hole such that said knob is slidably positioned on said shaft having said back end being spaced from said primary end of said bushing.

7. The device according to claim 6, wherein:
said device includes a knob set screw extending through said receiver section of said exterior wall of said knob and into said shaft hole; and
said knob set screw compresses against said outside surface of said shaft when said knob set screw is tightened for retaining said knob at a selected point along said shaft.

8. The device according to claim 6, wherein
said sleeve has a lip extending around said sleeve;
said device includes a biasing member extending around said bushing;
said biasing member extends between said lip on said sleeve and said back end of said knob;
said biasing member biases said knob to travel away from said sleeve; and
said biasing member is compressed when said knob is urged to travel toward said sleeve;
said shaft travels in a primary direction in said bushing when said knob is urged to travel toward said sleeve; and
said shaft travels in a secondary direction in said bushing when said knob is biased to travel away from said sleeve.

9. The device according to claim 8, wherein:
said device includes a locking collar having an outwardly facing surface extending between a forward surface and a rearward surface;
said bushing extends through said locking collar having said forward surface resting against said second end of said sleeve; and
said forward surface of said locking collar abuts said second end of said sleeve when said biasing member biases said knob to travel away from said sleeve such that said locking collar limits a distance said shaft can travel in said secondary direction.

10. The device according to claim 9, wherein:
said plunger includes a shaft;
said shaft has a first end and a second end; and
said locking collar is positionable on said bushing such that said second end of said shaft is spaced a selected distance from said drive wheel of said bandsaw when said biasing member biases said knob to travel away from said sleeve.

11. The device according to claim 9, wherein:
said plunger includes an annular gasket being positioned around said bushing;
said annular gasket is positioned between said forward surface of said locking collar and said second end of said sleeve; and
said annular gasket is comprised of resiliently compressible material such that said annular gasket is compressed between said forward surface of said locking collar and said second end of said sleeve when said biasing member biases said knob to travel away from said sleeve wherein said annular gasket is configured to reduce noise produced by vibration of said bandsaw.

12. The device according to claim 5, wherein:
said brake pad has a front end and a back end and an outermost surface extending between said front end and said back end;
said front end has a first well extending toward said back end;
said first well has a rear bounding surface;
said rear bounding surface has a second well extending toward said back end;
said second well has a first lateral bounding surface and a second lateral bounding surface;
said first lateral bounding surface being oriented perpendicular to said rear bounding surface;
said second lateral bounding surface being concavely arcuate with respect to said first lateral bounding surface such that said second well has a semicircular shape; and
said second well insertably receives said second end of said shaft having said first bounding surface of said cut out portion of said outside surface of said shaft conforming to said first lateral bounding surface of said second well such that said shaft is inhibited from rotating in said second well.

13. The device according to claim 12, wherein:
said plunger includes a knob being positioned around said shaft;
said device includes a friction pad having a coupled surface being coupled to said rear end of said brake pad having said coupled surface completely covering said rear end; and
an exposed surface of said friction pad presses against a lateral surface of said drive wheel when said knob is urged toward said sleeve to produce friction between said lateral surface of said drive wheel and said exposed surface of said friction pad.

14. The device according to claim 12, wherein:
said device includes a cushion being applied to said front end of said brake pad having said cushion extending around said first well; and
said cushion is comprised of a resiliently compressible material such that said cushion is compressed between said front end of said brake pad and an inner face of said door when said biasing member biases said knob to travel away from said sleeve wherein said cushion is configured to reduce noise produced by vibration of said bandsaw.

15. A bandsaw braking device for stopping rotation of a power tool when the power tool is turned off, said device comprising:
a bandsaw having a drive wheel being located in a drive wheel housing, said drive wheel housing having a door lying on a plane being oriented parallel to said drive wheel;
a sleeve being extendable through a sleeve hole in said door of said wheel housing, said sleeve having a first end and a second end and an outer wall extending between said first end and said second end, said outer wall having an outer surface being threaded between said first end and said second end, said sleeve having a lip extending away from said outer wall having said lip extending around a full circumference of said outer wall, said lip being aligned with said first end such that said lip rests against an outer face of said door when said sleeve is extended through said sleeve hole;
a nut being threadable onto said outer surface of said sleeve, said nut compressing against an inner face of said door when said nut is tightened on said sleeve for securing said sleeve in said sleeve hole;
a bushing being extendable through said sleeve such that said bushing extends through said door, said bushing having a primary end and a secondary end and an exterior wall extending between said primary end and said secondary end, said bushing having a length between said primary end and said secondary end which is greater than a length of said sleeve between said first end and said second end, said bushing being comprised of a friction reducing material such that said bushing slides freely in said sleeve;
a plunger being slidably positioned in said bushing wherein said plunger is configured to be pushed upon by the user, said plunger extending toward said drive wheel when said plunger is urged to travel in a first direction, said plunger being biased to travel in a second direction, said plunger comprising:
a shaft having first end and a second end and an outside surface extending between said first end of said shaft and said second end of said shaft, said shaft extending through said bushing having said outside surface slidably engaging an interior surface of said exterior wall of said bushing, said shaft being slidable in a primary direction in said bushing or a secondary direction in said bushing, said outside surface having a cut out portion extending from said second end of said shaft toward said first end of said shaft, said cut out portion having a first bounding surface lying on a plane being oriented perpendicular to said second end, said cut out portion having a second bounding surface being oriented perpendicular to said first bounding surface, said second bounding surface lying on a plane being oriented parallel to said second end;
a knob having a front end and a back end and an exterior wall extending between said front end and said back end, said exterior wall of said knob having a receiver section and a gripping section, said receiver section having a diameter being less than a diameter of said gripping section, said knob having a shaft hole extending through said front end and said back end, said shaft extending through said shaft hole such that said knob is slidably positioned on said shaft having said back end being spaced from said primary end of said bushing, said exterior wall of said knob associated with said gripping section having a plurality of intersecting surfaces being oriented at an angle with each other such that said gripping section has a polygonal shape wherein said gripping section is configured to enhance a grip of a user when the user grips said gripping section;
a knob set screw extending through said receiver section of said exterior wall of said knob and into said shaft hole, said knob set screw compressing against said outside surface of said shaft when said knob set screw is tightened for retaining said knob at a selected point along said shaft;
a biasing member extending around said bushing, said biasing member extending between said lip on said sleeve and said back end of said knob, said biasing member biasing said knob to travel away from said sleeve, said biasing member being compressed when said knob is urged to travel toward said sleeve, said shaft traveling in said primary direction in said bushing when said knob is urged to travel toward said sleeve, said shaft travelling in said secondary direction in said bushing when said knob is biased to travel away from said sleeve;
a locking collar having an outwardly facing surface extending between a forward surface and a rearward surface, said bushing extending through said locking collar having said forward surface resting against said second end of said sleeve, said forward surface of said locking collar abutting said second end of said sleeve when said biasing member biases said knob to travel away from said sleeve such that said locking collar limits a distance said shaft can travel in said secondary direction, said locking collar being positionable on said bushing such that said second end of said shaft is spaced a selected distance from said drive wheel of said bandsaw when said biasing member biases said knob to travel away from said sleeve;
a collar set screw extending through said outwardly facing surface of said locking collar, said collar set screw compressing against said exterior wall of said bushing when said collar set screw is tightened for inhibiting said locking collar from sliding along said exterior wall of said bushing; and
an annular gasket being positioned around said bushing, said annular gasket being positioned between said forward surface of said locking collar and said second end of said sleeve, said annular gasket being comprised of resiliently compressible material such that said annular gasket is compressed between said forward surface of said locking collar and said second end of said sleeve when said biasing member biases said knob to travel away from said sleeve wherein said annular gasket is configured to reduce noise produced by vibration of said bandsaw;
a brake pad being removably attachable to said plunger, said brake pad pressing against said drive wheel when said plunger is urged to travel in said first direction having said brake pad frictionally engaging said drive wheel such that said brake pad stops rotation of said drive wheel wherein said brake pad is configured to stop rotation of said bandsaw when the user presses upon said plunger, said brake pad being spaced from said drive wheel when said plunger is biased to travel in said second direction such that said drive wheel can rotate freely, said brake pad having a forward end and a rear end and an outermost surface extending between said forward end and said rear end, said forward end having a first well extending toward said rear end, said first well having a rear bounding surface, said rear bounding surface having a second well extending toward said rear end, said second well has a first lateral bounding surface and a second lateral bounding surface, said first lateral bounding surface being oriented perpendicular to said rear bounding surface, said second lateral bounding surface being concavely arcuate with respect to said first lateral bounding surface such that said second well has a semicircular shape, said second well insertably receives said second end of said shaft having said first bounding surface of said cut out portion of said outside surface of said shaft conforming to said first lateral bounding surface of said second well such that said shaft is inhibited from rotating in said second well;
a brake set screw extending through said outermost surface of said brake pad, said brake set screw compressing against said first bounding surface of said cut out portion of said outside surface of said shaft when said brake set screw is tightened for retaining said brake pad on said head;
a friction pad having a coupled surface being coupled to said rear end of said brake pad having said coupled surface completely covering said rear end, an exposed surface of said friction pad pressing against a lateral surface of said drive wheel when said knob is urged toward said sleeve to produce friction between said lateral surface of said drive wheel and said exposed surface of said friction pad; and
a cushion being applied to said forward end of said brake pad having said cushion extending around said first well, said cushion being comprised of a resiliently compressible material such that said cushion is compressed between said forward end of said brake pad and an inner face of said door when said biasing member biases said knob to travel away from said sleeve wherein said cushion is configured to reduce noise produced by vibration of said bandsaw.
